(19) United States
(12) Patent Application Publication
(10) Pub. No.: US 2008/0021828 A1
(43) Pub. Date: Jan. 24, 2008

(54) Method and apparatus for automatically obtaining financial information from a financial institution

(76) Inventors: Jefrey O. Pfeiffer, Lewisville, TX (US); Michael J. Rainwater, Frisco, TX (US); Kathy A. Kirkendall, La Jolla, CA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/489,314

(22) Filed: Jul. 19, 2006

(51) Int. Cl. G06Q 40/00

(52) U.S. Cl. 705/42

(57) ABSTRACT

One embodiment of the present invention provides a system for determining a set of commands to download check-images from an online-banking-application. During operation, the system receives a plurality of command-sets from an application, wherein a command-set is a sequence of commands that causes an online-banking-application to send one or more check-images to the application. Next, the system compares the command-sets to determine a minimal set of commands that cause the online-banking-application to send the check-images to the application. The system then sends the minimal set of commands to one or more applications which download check-images from the online-banking-application.

One embodiment of the present invention provides a system for performing automatic check reconciliation. During operation, the system receives a check-image from an online-banking-application. Subsequently, the system processes the check-image to obtain financial information associated with a check represented by the check-image. Next, the system creates a ledger-entry for the check-image, wherein the ledger-entry is a record of a financial transaction. The system then populates the ledger-entry with the financial information to obtain a populated ledger-entry.

### BACKGROUND

### Related Art

Accountants typically have a large number of clients, and it can often be difficult for accountants to periodically obtain necessary financial information from their clients. Many of these accountants use software to facilitate the process of obtaining and organizing their clients' financial information, which can save a significant amount of time. However, despite this time-savings, for an accountant with a large number of clients, gathering and organizing financial information is still a very time-consuming process.

Often, the software that accountants use to gather such financial information provides features that can be used to obtain financial information from a financial institution via a web-interface. However, the web-interface typically differs for each financial institution. As a result, software developers typically have to spend a significant amount of time designing and configuring the accounting software to communicate with different financial institutions. Furthermore, each time a financial institution alters its web-interface, or the software developers add support for a new financial institution, the software developers must spend even more time updating the accounting software.

In the past, financial institutions typically provided their clients with cancelled checks to facilitate account reconciliation. Today, financial institutions are less likely to send a copy of a financial document, such as a check, to a client. Instead, many financial institutions provide an electronic copy of the document via their afore-mentioned web-interface. Furthermore, these financial institutions only transcribe a small portion of the financial information included in the financial document into a form that the accounting software can easily interpret. Hence, it can be difficult for the accounting software to process many financial documents without user assistance.

### SUMMARY

One embodiment of the present invention provides a system for determining a set of commands to download check-images from an online-banking-application. During operation, the system receives a plurality of command-sets from an application, wherein a command-set is a sequence of commands that causes an online-banking-application to send one or more check-images to the application. Next, the system compares the command-sets to determine a minimal set of commands that cause the online-banking-application to send the check-images to the application. The system then sends the minimal set of commands to one or more applications which download check-images from the online-banking-application.

In a variation on this embodiment, receiving the plurality of command-sets additionally involves receiving responses to the corresponding sequences of commands, wherein the online-banking-application generates the responses.

In a variation on this embodiment, receiving the plurality of command-sets from the application involves receiving the plurality of command-sets from multiple applications.

One embodiment of the present invention provides a system for determining a minimal set of commands to download check-images from an online-banking-application. During operation, the system sends a command to an online-banking-application. The system then receives a response to the command from the online-banking-application. Subsequently, the system examines the response to determine if the response includes a check-image. If so, the system sends a command-set which includes the command to a database. The database then determines a minimal set of commands to download check-images by comparing the command-set to other command-sets that cause the online-banking-application to send a check-image to the system. The database then sends to the system the minimal set of commands to download check-images.

In a variation on this embodiment, the command-set includes a sequence of commands beginning with a pre-defined starting-command and ending with a command that caused the system to download a check-image from the online-banking-application.

In a variation on this embodiment, sending the command-set involves sending a response that the online-banking-application generates to the database for each command in the command-set, which enables the database to determine the minimal set of commands to download check-images.

In a further variation, prior to sending the response generated by the online-banking-application to the database, the system removes all sensitive information from the response that the online-banking-application generates.

In a further variation, the sensitive information can include: a user name; an account number; a password; an account balance; and transaction information.

In a variation on this embodiment, after receiving the minimal set of commands from the database, the system combines login-information with the minimal set of commands to facilitate downloading check-images from the online-banking-application without user interaction.

One embodiment of the present invention provides a system for performing automatic check reconciliation. During operation, the system receives a check-image from an online-banking-application. Subsequently, the system processes the check-image to obtain financial information associated with a check represented by the check-image. Next, the system creates a ledger-entry for the check-image, wherein the ledger-entry is a record of a financial transaction. The system then populates the ledger-entry with the financial information to obtain a populated ledger-entry.

In a variation on this embodiment, populating the ledger-entry further involves storing the check-image in a storage medium which also contains the ledger-entry. The system then associates the check-image with the ledger-entry.

In a variation on this embodiment, processing the check-image involves using pre-defined areas on the check to identify a section of the check-image that includes an item of financial information. The system then performs an information-retrieval process on the section of the check-image to obtain the item of financial information.

In a further variation, the information-retrieval process involves performing an Optical Character Recognition (OCR) operation.

In a variation on this embodiment, the financial information can include: a payee name; a payer name; a bank name; a check number; an account number; a routing number; an issue date which specifies when a user issued the check; a processing date which specifies when a bank processed the check; a check amount; a signature; and a memorandum.

In a variation on this embodiment, the system presents the populated ledger-entry to a user. Next, the system receives edited financial information from the user. In response to receiving the edited financial information, the system updates the ledger-entry with the edited financial information to obtain an updated populated ledger-entry.

In a variation on this embodiment, creating the ledger entry involves updating an existing ledger-entry.

### BRIEF DESCRIPTION OF THE FIGURES

FIG. 1 illustrates a computing environment in accordance with an embodiment of the present invention.

FIG. 2 presents a flowchart illustrating the process of determining a minimal set of commands to download a check-image in accordance with an embodiment of the present invention.

FIG. 3 presents a flowchart illustrating the process of identifying a command-set in accordance with an embodiment of the present invention.

FIG. 4 presents a flowchart illustrating the process of populating a ledger-entry with financial information retrieved from a check-image in accordance with an embodiment of the present invention.

FIG. 5 presents a flowchart illustrating the process of processing a check-image in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

One embodiment of the present invention provides a check-image reconciliation system, which includes a pattern-recognition engine. The pattern-recognition engine collects check-image retrieval information that describes how users interact with an online-banking-application to retrieve check-images. Next, the pattern-recognition engine transforms the collected check-image retrieval information into a minimal set of commands to download check-images from the online-banking-application. Subsequently, the pattern-recognition engine sends the minimal set of commands to a server, which distributes the minimal set of commands to applications whose users interact with the online-banking-application. Note that the pattern-recognition engine effectively learns how to interact with the online-banking-application. Thus, once the pattern-recognition engine collects enough check-image retrieval information, the check-image reconciliation system can download check-images from the online-banking-application without user interaction.

In one embodiment of the present invention, the pattern-recognition engine includes a web-browser embedded within an application that a user can use to interact with the online-banking-application. During this process, the embedded web-browser can collect the check-image retrieval information using a command-capture process, which can involve recording which web-pages the embedded web-browser loads, detecting mouse clicks, detecting Document Object Model (DOM) events, or any other command-capture process known to those familiar with the art. Before providing the check-image retrieval information to the pattern-recognition engine, the embedded web-browser can remove sensitive information, such as account numbers.

Once the check-image reconciliation system has received a check-image, the check-image reconciliation system can use an information retrieval process to obtain financial information from the check-image. The check-image reconciliation system can then store the financial information and the check-image in non-volatile storage.

In one embodiment of the present invention, the check-image reconciliation system can be combined with a financial information retrieval system that uses Open Financial Exchange (OFX) technology to obtain financial information from an online-banking-application. In this embodiment, the financial information retrieval system can obtain processed financial information provided by the online-banking-application, and the check-image reconciliation system can obtain a check-image. The check-image reconciliation system then extracts financial information from the check-image that is not typically provided by an online-banking-application, such as a payee name. Note that the financial information retrieval system can be a browser-based or non browser-based system.

### Computing Environment

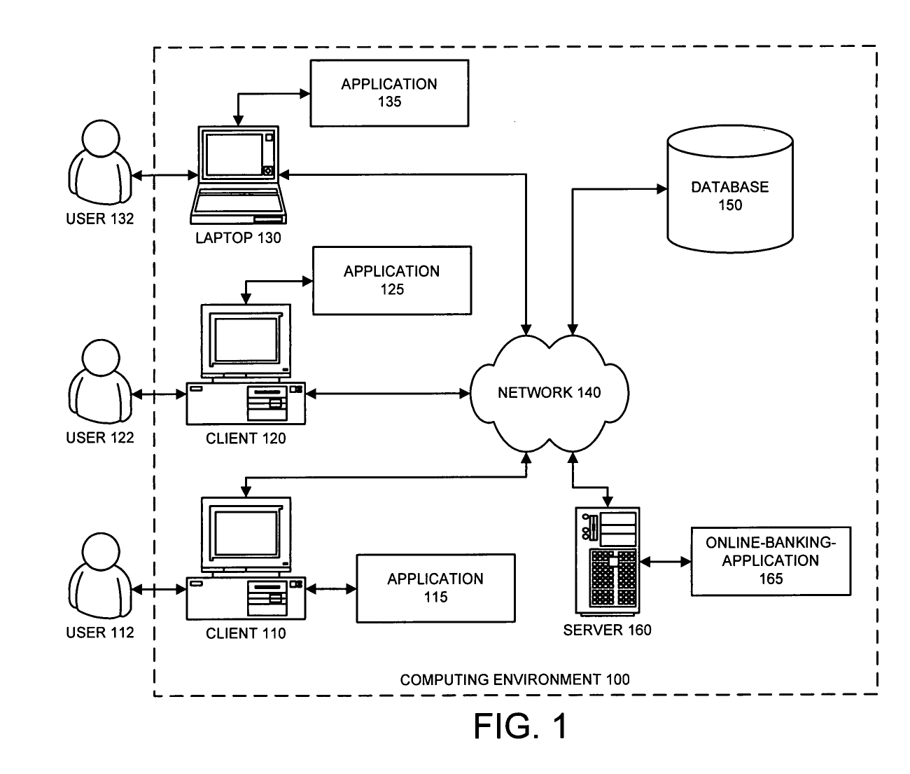

FIG. 1 illustrates a computing environment 100 in accordance with an embodiment of the present invention.

Computing environment 100 includes a number of computer systems. These computer systems can generally include any type of computer system on a microprocessor, a mainframe computer, a digital signal processor, a portable computing device, a personal organizer, a device controller, and a computational engine within an appliance. More specifically, computing environment 100 includes client 110, client 120, laptop 130, application 115, application 125, application 135, network 140, database 150, server 160, and online-banking-application 165.

Clients 110 and 120, and laptop 130 can generally include any node on a network including computational capability and including a mechanism for communicating across the network.

Applications 115, 125, and 135, and online-banking-application 165 can generally include any computer program. As illustrated in FIG. 1, client 110 executes application 115, client 120 executes application 125, laptop 130 executes application 135, and server 160 executes online-banking-application 165. During operation, applications 115, 125, and 135 communicate with online-banking-application 165.

Network 140 can generally include any type of wired or wireless communication channel capable of coupling together computing nodes. This includes, but is not limited to, a local area network, a wide area network, or a combination of networks. In one embodiment of the present invention, network 140 comprises the Internet.

Database 150 can generally include any type of system for storing data in non-volatile storage. This includes, but is not limited to, systems based upon magnetic, optical, and magneto-optical storage devices, as well as storage devices based on flash memory and/or battery-backed up memory.

In one embodiment of the present invention, client 110 hosts database 150.

Server 160 can generally include any node on a computer network which comprises a mechanism for servicing requests from a client for computational and/or data storage resources.

In one embodiment of the present invention, user 112 is an accountant who uses application 115 to obtain financial information for user 112's clients from online-banking-application 165. User 112 communicates with online-banking-application 165 through a web-browser included with application 115 to retrieve a list of transactions for a client, such as user 132.

Suppose that upon examining the list of transactions, user 112 notices a discrepancy between the financial information user 132 provided and the financial information that user 112 retrieved from online-banking-application 165. To find out more about this discrepancy, user 112 downloads a check-image associated with the discrepancy from online-banking-application 165. Then, application 115 processes the check-image to retrieve financial information associated with the corresponding check. Application 115 then updates a ledger-entry that includes the financial information that user 132 provided to include the financial information obtained from the check-image.

In one embodiment of the present invention, while user 112 is using application 115 to interact with online-banking-application 165, application 115 records the commands sent to online-banking-application 165, and the corresponding responses received from online-banking-application 165. Application 115 can then send the recorded commands and responses to database 150, which uses this information to determine a minimal set of commands for downloading a check-image. Subsequently, database 150 sends the minimal set of commands for downloading a check-image to applications 115, 125, and 135. Users 112, 122, and 132 can then instruct applications 115, 125, and 135 to download and process check-images without further user interaction.

### Determining Commands for Downloading a Check-Image

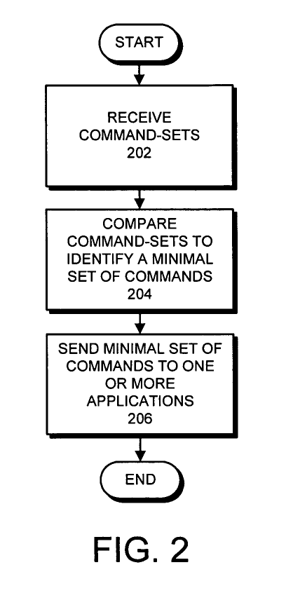

FIG. 2 presents a flowchart illustrating the process of determining a minimal set of commands to download a check-image in accordance with an embodiment of the present invention.

The process begins when database 150 receives a plurality of command-sets from an application, such as application 115, or a set of applications, such as applications 115, 125, and 135 (step 202). Note that a command-set can include a sequence of commands that cause online-banking-application 165 to send one or more check-images to application 115. In one embodiment of the present invention, for each command in a command-set, database 150 receives a record of a response generated by online-banking application 165 for the command. Note that the record of the response can include a copy of the response, and/or an indicator specifying the response type.

Next, database 150 compares the command-sets to determine a minimal set of commands that cause online-banking-application 165 to send check-images to application 115 (step 204). Note that comparing the command-sets can involve comparing the responses to the commands that make up the command-set. After determining the minimal set of commands that cause online-banking-application 165 to send check-images to application 115, database 150 sends the minimal set of commands to applications 115, 125, and 135 (step 206). This enables applications 115, 125, and 135 to automatically retrieve check-images from online-banking-application 165.

### Identifying a Command-Set

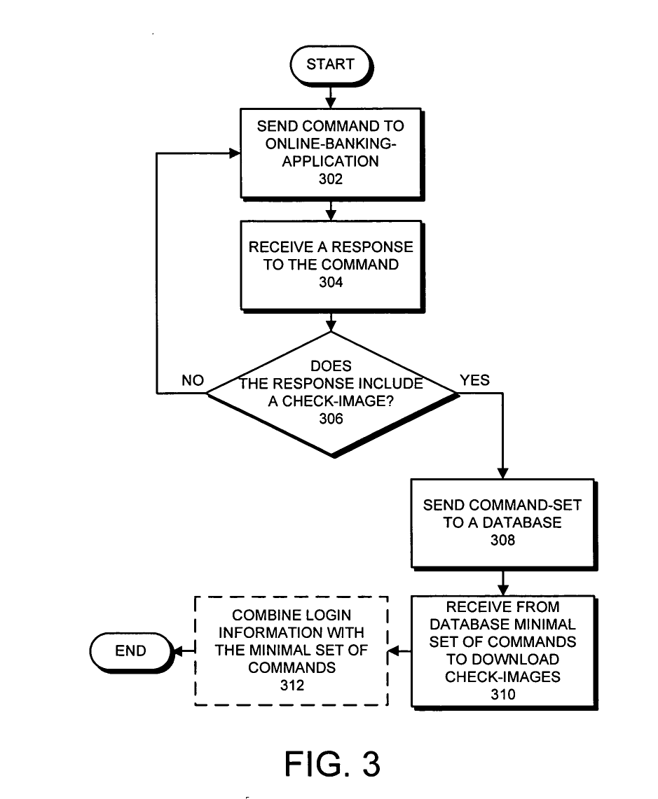

FIG. 3 presents a flowchart illustrating the process of identifying a command-set in accordance with an embodiment of the present invention.

The process begins with application 115 sending a command to online-banking-application 165 (step 302). Next, application 115 receives a response to the command from online-banking-application 165 (step 304). Application 115 then records the command and the response to the command to facilitate determining a command-set. Next, application 115 examines the response to the command to determine if the response includes a check-image (step 306). If not, application 115 repeats step 302.

If the response includes a check-image, application 115 sends a command-set to database 150 (step 308). This command-set includes a sequence of commands beginning with a pre-defined starting-command and ending with the command associated with the response that includes the check-image. The pre-defined starting-command can be the command that initiated communication between application 115 and online-banking-application 165, or any other command specified by user 112. Prior to sending the command-set to database 150, application 115 can remove sensitive information from the responses associated with the commands included with the command-set. This sensitive information can include: a user name, an account number, a password, an account balance, transaction information, or any other information that user 112 specifies as sensitive information.

After sending the command-set to database 150, application 115 receives a minimal set of commands to download check-images from online-banking-application 165 (step 310). This minimal set of commands enables application 115 to retrieve check-images from online-banking-application 165 with minimal user-interaction. User 112 can then initiate check-image retrieval with a single command.

In one embodiment of the present invention, application 115 can combine login information with the minimal set of commands to download check-images, thereby enabling application 115 to download check-images from online-banking-application 165 without user-interaction (step 312). This step is optional as is illustrated by the dashed lines surrounding step 312.

### Populating a Ledger-Entry

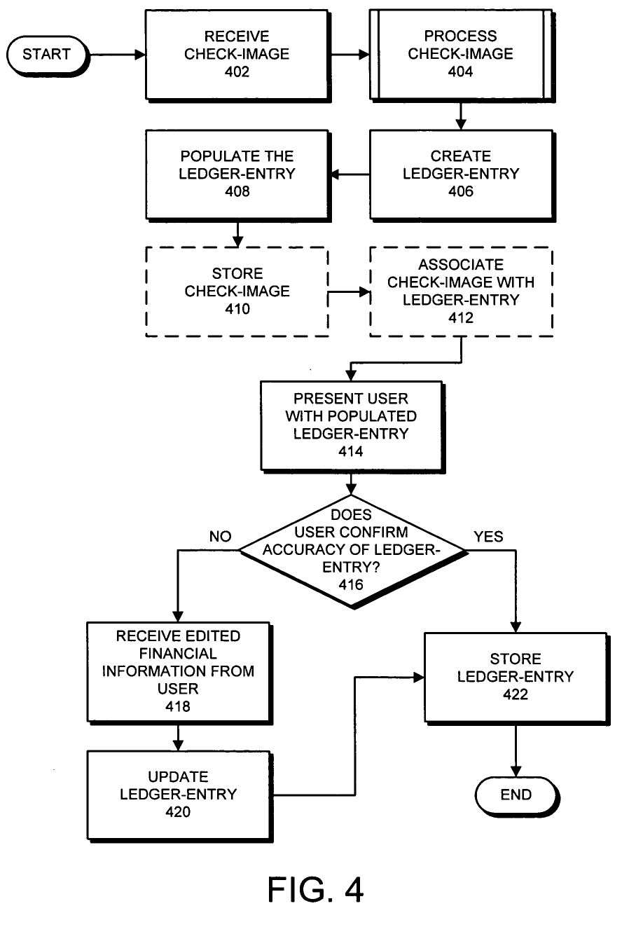

FIG. 4 presents a flowchart illustrating the process of populating a ledger-entry with financial information retrieved from a check-image in accordance with an embodiment of the present invention.

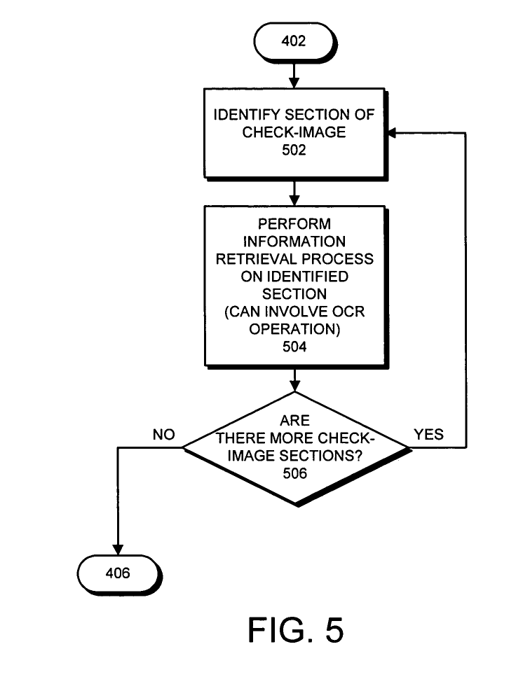

The process begins when application 115 receives a check-image from online-banking-application 165 (step 402). Application 115 then processes the check-image to obtain financial information associated with a check represented by the check-image (step 404). Note that the financial information can include: a payee name, a payer name, a bank name, a check number, an account number, a routing number, an issue date which specifies when user 112 issued the check, a processing date which specifies when a bank processes the check, a check amount, a signature, a memorandum, and any other financial information that can be obtained from a check-image. Furthermore, note that this is a multi-step process, which is described in more detail below with reference to FIG. 5.

Next, application 115 creates a ledger-entry associated with the check-image (step 406). A ledger-entry can be a record of a financial transaction. In the event that a ledger-entry associated with the check-image already exists, application 115 can retrieve the ledger-entry from non-volatile storage. Application 115 then populates the ledger-entry with the financial information retrieved from the check-image to produce a populated ledger-entry (step 408).

Next, application 115 stores the check-image in a non-volatile storage medium that contains the populated ledger-entry (step 410). Application 115 then associates the check-image with the populated ledger-entry (step 412). These steps are optional as is illustrated by the dashed lines surrounding steps 410 and 412.

After populating the ledger-entry, application 115 presents the populated ledger-entry to user 112 (step 414). Application 115 then asks user 112 to confirm the accuracy of the financial information included in the populated ledger-entry (step 416). If user 112 confirms the accuracy, application 115 stores the populated ledger-entry in a non-volatile storage medium (step 422). Note that user 112 can pre-specify the location of the non-volatile storage medium, or can specify the location of the non-volatile storage medium when confirming the accuracy of the populated ledger-entry. If user 112 does not confirm the financial information included with the populated ledger-entry as accurate, application 115 can receive edited financial information from user 112 (step 418). In response to receiving the edited financial information, application 115 updates the populated ledger-entry with the edited financial information to obtain an updated populated ledger-entry (step 420). Application 115 then proceeds to step 422.

In one embodiment of the present invention, application 115 can store the populated ledger-entry in the non-volatile storage medium (step 422) without first presenting the populated ledger-entry to user 112. In this embodiment, user 112 pre-specifies the non-volatile storage medium that stores the populated ledger-entry. This embodiment enables application 115 to retrieve and process check-images without user interaction.

### Processing a Check-Image

FIG. 5 presents a flowchart illustrating the process of processing a check-image in accordance with an embodiment of the present invention.

The process begins when application 115 identifies a section of a check-image (step 502). The sections of the check-image are pre-defined areas of the check-image that include an item of financial information. In one embodiment of the present invention, application 115 performs an Optical Character Recognition (OCR) operation to identify the sections of the check-image.

Next, application 115 performs an information-retrieval process on the section of the check-image to obtain an item of financial information included in the section of the check-image (step 504). This information-retrieval process can involve performing an OCR operation to obtain the item of financial information.

Application 115 then determines if there are more check-image sections to process (step 506). If so, application 115 returns to step 502. If not, application 115 proceeds to step 406.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for determining a set of commands to download check-images from an online-banking-application, comprising:
receiving a plurality of command-sets from an application, wherein a command-set is a sequence of commands that causes an online-banking-application to send one or more check-images to the application;
comparing the command-sets to determine a minimal set of commands that cause the online-banking-application to send the check-images to the application; and
sending the minimal set of commands to one or more applications which download check-images from the online-banking-application.

2. The method of claim 1, wherein receiving the plurality of command-sets additionally involves receiving responses to the corresponding sequences of commands, wherein the responses are generated by the online-banking-application.

3. The method of claim 1, wherein receiving the plurality of command-sets from the application involves receiving the plurality of command-sets from multiple applications.

4. A method for determining a minimal set of commands to download check-images from an online-banking-application, comprising:
sending a command to an online-banking-application;
receiving a response to the command from the online-banking-application;
examining the response to determine if the response includes a check-image; and
if so,
sending a command-set which includes the command to a database which determines a minimal set of commands to download check-images by comparing the command-set to other command-sets that cause a check-image to be downloaded from the online-banking-application, and
receiving from the database the minimal set of commands to download check-images.

5. The method of claim 4, wherein the command-set includes a sequence of commands beginning with a pre-defined starting-command and ending with a command that caused a check-image to be downloaded from the online-banking-application.

6. The method of claim 4, wherein sending the command-set involves sending a response generated by the online-banking-application to the database for each command in the command-set, which enables the database to determine the minimal set of commands to download check-images.

7. The method of claim 6, wherein prior to sending the response generated by the online-banking-application to the database, the method further comprises removing sensitive information from the response generated by the online-banking-application.

8. The method of claim 7, wherein the sensitive information can include:
a user name;
an account number;
a password;
an account balance; and
transaction information.

9. The method of claim 4, wherein after receiving the minimal set of commands from the database, the method further comprises combining login-information with the minimal set of commands to facilitate downloading check-images from the online-banking-application without user interaction.

10. A method for performing automatic check reconciliation, comprising:
receiving a check-image from an online-banking-application;
processing the check-image to obtain financial information associated with a check represented by the check-image;
creating a ledger-entry for the check-image, wherein the ledger-entry is a record of a financial transaction; and
populating the ledger-entry with the financial information to obtain a populated ledger-entry.

11. The method of claim 10, wherein populating the ledger-entry further involves:
storing the check-image in a storage medium which also stores the ledger-entry; and
associating the check-image with the ledger-entry.

12. The method of claim 10, wherein processing the check-image involves:
using pre-defined areas on the check to identify a section of the check-image that includes an item of financial information; and
performing an information-retrieval process on the section of the check-image to obtain the item of financial information.

13. The method of claim 12, wherein the information-retrieval process involves performing an Optical Character Recognition (OCR) operation.

14. The method of claim 10, wherein the financial information can include:
a payee name;
a payer name;
a bank name;
a check number;
an account number;
a routing number;
an issue date which specifies when a user issued the check;
a processing date which specifies when a bank processed the check;
a check amount;
a signature; and
a memorandum.

15. The method of claim 10, further comprising:
presenting the populated ledger-entry to a user;
receiving edited financial information from the user; and
in response to receiving the edited financial information, updating the ledger-entry with the edited financial information to obtain an updated populated ledger-entry.

16. The method of claim 10, wherein creating the ledger entry involves updating an existing ledger-entry.

17. A computer-readable storage medium storing instructions that when executed by a computer cause the computer to perform a method for determining a set of commands to download check-images from an online-banking-application, the method comprising:
receiving a plurality of command-sets from an application, wherein a command-set is a sequence of commands that causes an online-banking-application to send one or more check-images to the application;
comparing the command-sets to determine a minimal set of commands that cause the online-banking-application to send the check-images to the application; and
sending the minimal set of commands to one or more applications which download check-images from the online-banking-application.

18. The computer-readable storage medium of claim 17, wherein receiving the plurality of command-sets additionally involves receiving responses to the corresponding sequences of commands, wherein the responses are generated by the online-banking-application.

19. The computer-readable storage medium of claim 17, wherein receiving the plurality of command-sets from the application involves receiving the plurality of command-sets from multiple applications.

20. A computer-readable storage medium storing instructions that when executed by a computer cause the computer to perform a method for determining a minimal set of commands to download check-images from an online-banking-application, the method comprising:
sending a command to an online-banking-application;
receiving a response to the command from the online-banking-application;
examining the response to determine if the response includes a check-image; and
if so,
sending a command-set which includes the command to a database which determines a minimal set of commands to download check-images by comparing the command-set to other command-sets that cause a check-image to be downloaded from the online-banking-application, and
receiving from the database the minimal set of commands to download check-images.

21. The computer-readable storage medium of claim 20, wherein the command-set includes a sequence of commands beginning with a pre-defined starting-command and ending with a command that caused a check-image to be downloaded from the online-banking-application.

22. The computer-readable storage medium of claim 20, wherein sending the command-set involves sending a response generated by the online-banking-application to the database for each command in the command-set, which enables the database to determine the minimal set of commands to download check-images.

23. The computer-readable storage medium of claim 22, wherein prior to sending the response generated by the online-banking-application to the database, the method further comprises removing sensitive information from the response generated by the online-banking-application.

24. The computer-readable storage medium of claim 23, wherein the sensitive information can include:
a user name;
an account number;
a password;
an account balance; and
transaction information.

25. The computer-readable storage medium of claim 20, wherein after receiving the minimal set of commands from the database, the method further comprises combining login-information with the minimal set of commands to facilitate downloading check-images from the online-banking-application without user interaction.

26. A computer-readable storage medium storing instructions that when executed by a computer cause the computer to perform a method for performing automatic check reconciliation, the method comprising:
receiving a check-image from an online-banking-application;
processing the check-image to obtain financial information associated with a check represented by the check-image;
creating a ledger-entry for the check-image, wherein the ledger-entry is a record of a financial transaction; and
populating the ledger-entry with the financial information to obtain a populated ledger-entry.

27. The computer-readable storage medium of claim 26, wherein populating the ledger-entry further involves:
storing the check-image in a storage medium which also stores the ledger-entry; and
associating the check-image with the ledger-entry.

28. The computer-readable storage medium of claim 26, wherein processing the check-image involves:
using pre-defined areas on the check to identify a section of the check-image that includes an item of financial information; and
performing an information-retrieval process on the section of the check-image to obtain the item of financial information.

29. The computer-readable storage medium of claim 28, wherein the information-retrieval process involves performing an Optical Character Recognition (OCR) operation.

30. The computer-readable storage medium of claim 26, wherein the financial information can include:
a payee name;
a payer name;
a bank name;
a check number;
an account number;
a routing number;
an issue date which specifies when a user issued the check;
a processing date which specifies when a bank processed the check;
a check amount;
a signature; and
a memorandum.

31. The computer-readable storage medium of claim 26, wherein the method further comprises:
presenting the populated ledger-entry to a user;
receiving edited financial information from the user; and
in response to receiving the edited financial information, updating the ledger-entry with the edited financial information to obtain an updated populated ledger-entry.

32. The computer-readable storage medium of claim 26, wherein creating the ledger entry involves updating an existing ledger-entry.

33. An apparatus that determines a set of commands to download check-images from an online-banking-application, comprising:
a receiving mechanism configured to receive a plurality of command-sets from an application, wherein a command-set is a sequence of commands that causes an online-banking-application to send one or more check-images to the application;
a comparing mechanism configured to compare the command-sets to determine a minimal set of commands that cause the online-banking-application to send the check-images to the application; and
a sending mechanism configured to send the minimal set of commands to one or more applications which download check-images from the online-banking-application.

34. The apparatus of claim 33, wherein the receiving mechanism is further configured to receive responses to the corresponding sequences of commands associated with the plurality of command-sets, wherein the responses are generated by the online-banking-application.

35. The apparatus of claim 33, wherein the receiving mechanism is further configured to receive the plurality of command-sets from multiple applications.

36. An apparatus that determines a minimal set of commands to download check-images from an online-banking-application, comprising:
a sending mechanism configured to:
send a command to an online-banking-application, and to
send a command-set which includes the command to a database which determines a minimal set of commands to download check-images by comparing the command-set to other command-sets that cause a check-image to be downloaded from the online-banking-application;
a receiving mechanism configured to:
receive a response to the command from the online-banking-application, and to
receive from the database the minimal set of commands to download check-images; and
an examination mechanism configured to examine the response to determine if the response includes a check-image.

37. The apparatus of claim 36, wherein the sending mechanism is further configured to send a response generated by the online-banking-application to the database for each command in the command-set, which enables the database to determine the minimal set of commands to download check-images.

38. The apparatus of claim 37, further comprising a sanitizing mechanism configured to remove sensitive information from the response generated by the online-banking-application.

39. The apparatus of claim 36, further comprising a combining mechanism configured to combine login-information with the minimal set of commands to facilitate downloading check-images from the online-banking-application without user interaction.

40. An apparatus that performs automatic check reconciliation, comprising:
a receiving mechanism configured to receive a check-image from an online-banking-application;
a processing mechanism configured to process the check-image to obtain financial information associated with a check represented by the check-image;
a creation mechanism configured to create a ledger-entry for the check-image, wherein the ledger-entry is a record of a financial transaction; and
a population mechanism configured to populate the ledger-entry with the financial information to obtain a populated ledger-entry.

41. The apparatus of claim 40, wherein the populating mechanism further comprises:
a storing mechanism configured to store the check-image in a storage medium which also stores the ledger-entry; and
an association mechanism configured to associate the check-image with the ledger-entry.

42. The apparatus of claim 40, wherein the processing mechanism further comprises:
an identification mechanism configured to use pre-defined areas on the check to identify a section of the check-image that includes an item of financial information; and
a performing mechanism configured to perform an information-retrieval process on the section of the check-image to obtain the item of financial information.

43. The apparatus of claim 42, wherein the performing mechanism is further configured to perform an Optical Character Recognition (OCR) operation.

44. The apparatus of claim 40, further comprising:
a presentation mechanism configured to present the populated ledger-entry to a user;
a receiving mechanism configured to receive edited financial information from the user; and
an updating mechanism configured to update the ledger-entry with the edited financial information to obtain an updated populated ledger-entry.

45. The apparatus of claim 40, wherein the creating mechanism is further configured to update an existing ledger-entry.
